(19) United States
(12) Patent Application Publication
(10) Pub. No.: US 2021/0004889 A1
(43) Pub. Date: Jan. 7, 2021

(54) TRANSLATING AND PRESENTING PARAMETER VALUE INFORMATION

(71) Applicant: Alibaba Group Holding Limited, George Town (KY)

(72) Inventors: Ruihua Diao, Hangzhou (CN); Bingbing Shen, Beijing (CN); Zhenlei Wang, Hangzhou (CN); Jiayu Wang, Hangzhou (CN)

(21) Appl. No.: 17/002,032

(22) Filed: Aug. 25, 2020

Related U.S. Application Data
(63) Continuation-in-part of application No. PCT/CN19/75323, filed on Feb. 18, 2019.

(30) Foreign Application Priority Data
Feb. 27, 2018 (CN) 201810162132.2

(51) Int. Cl. G06Q 30/06; G06F 40/56

(52) U.S. Cl. CPC G06Q 30/0629; G06F 40/56

(57) ABSTRACT

Translating and presenting parameter value information is disclosed, including: determining data object information pertaining to a target data object; obtaining parameter value information relating to a set of target parameters from the data object information; translating the parameter value information into textual descriptive information based at least in part on a set of translation rules corresponding to the set of target parameters; and outputting the textual descriptive information to be presented at a user interface.

### CROSS REFERENCE TO OTHER APPLICATIONS

This application is a continuation-in-part of and claims priority to International (PCT) Application No. PCT/CN2019/75323, entitled METHOD AND DEVICE FOR GENERATING AND DISPLAYING DATA OBJECT INFORMATION filed on Feb. 18, 2019, which is incorporated herein by reference in its entirety for all purposes, which claims priority to China Patent Application No. 201810162132.2, entitled METHOD AND MEANS FOR GENERATING AND PRESENTING DATA OBJECT INFORMATION filed on Feb. 27, 2018 which is incorporated by reference in its entirety for all purposes.

### FIELD OF THE INVENTION

The present application relates to a field of data object information processing. In particular, it relates to techniques for translating and presenting parameter information.

### BACKGROUND OF THE INVENTION

As the Internet becomes more widespread, an ever-increasing number of users are making purchases through online marketing systems. Users may view the information on particular data objects in multiple ways including searching, homepage navigation, and category navigation. Moreover, they may make comparisons between data objects of the same category, and so on. The ultimate objective of this series of actions is to make a purchase decision. Therefore, the question of specifically how to disclose and display descriptive information concerning product objects to users is of paramount importance. As such, the quality of such product object descriptive information has a direct impact on a user's purchase decision.

Some product objects have some quantifiable parameter information. For example, some product objects in the electronic device category generally have multiple pieces of parameter information such as screen dimensions, pixels, and battery capacity. Conventionally, it is possible to disclose the aforementioned parameter information through pages such as product object list pages (e.g., search result lists, category lists, store lists, etc.) or product details pages. The users may make purchase decisions by viewing this parameter information.

However, some parameters and parameter values may seem rather abstract to ordinary users. For example, the battery capacity of a particular phone is 3000 mAh, but the ordinary user may not have a clear idea concerning this value and may be unable to understand what this value means. To give another example, the screen size of a certain phone is 4.7 inches. Again, the ordinary user might not be able to understand specifically how large 4.7 inches is, and so on. Thus, although detailed information is provided on product information interfaces, it may not be very helpful to users making purchase decisions. Or users can only use the conventionally presented parameter information to indirectly acquire more information. For example, users can use search engine systems to make queries concerning the meanings represented by specific parameter values, or they ask other people, etc.

Therefore, it is desirable to produce a more effective presentation of parameter information.

### SUMMARY OF THE INVENTION

The present application discloses techniques comprising:

determining data object information pertaining to a target data object;

obtaining parameter value information relating to a set of target parameters from the data object information;

translating the parameter value information into textual descriptive information based at least in part on a set of translation rules corresponding to the set of target parameters; and

outputting the textual descriptive information to be presented at a user interface.

### BRIEF DESCRIPTION OF THE DRAWINGS

Various embodiments of the invention are disclosed in the following detailed description and the accompanying drawings.

FIG. 1 is a diagram showing an embodiment of a system for translating and presenting parameter value information.

FIG. 2 is a flow diagram showing an embodiment of a process for translating parameter value information.

FIG. 3 is a flow diagram showing an embodiment of a process for presenting translated parameter value information.

FIG. 4 is a diagram showing an example user interface of a target page.

FIG. 5 is a flow diagram showing an embodiment of a process for presenting parameter value information.

FIG. 6 is a diagram showing an example of a system for translating and presenting parameter value information.

FIG. 7 is a diagram showing an example of a system for presenting translated parameter value information.

FIG. 8 is a diagram showing an example of a system for presenting translated parameter value information.

FIG. 9 is a schematic diagram that presents the architecture of a computer system.

FIG. 10 is a schematic diagram showing the architecture of an electronic device.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The technical schemes in the embodiments of the present application will be clearly and completely described in light of the drawings in specific embodiments of the present application. Obviously, the described embodiments are merely some of the embodiments of the present application and not all the embodiments. So long as no additional creative effort is expended, all other embodiments that are obtained by persons with ordinary skill in the art on the basis of embodiments in the present application fall within the scope of protection of the present application.

Embodiments of translating and presenting parameter value information are described herein. Data object information pertaining to a target data object is determined. Parameter value information relating to a set of target parameters is obtained from the data object information. The parameter value information is translated into textual descriptive information based at least in part on a set of translation rules corresponding to the set of target parameters. The textual descriptive information is outputted to be presented at a user interface.

As will be described in further detail below, a data object with parameter value information may first undergo processing to translate the specific parameter values into standardized and predefined textual, descriptive information that is relatively non-technical and easy to understand for ordinary users. For example, assume that the parameter value for one parameter, the battery capacity of a mobile terminal device such as a phone, is 5,000 mAh. In this case, the “5,000 mAh” parameter value can be translated by predetermined translation rules into the textual descriptive information of “super-long standby.” Thus, when specifically presented on a data object page, the translated, relatively non-technical, easy-to-understand textual descriptive information can be presented on the page to better help the user make a purchase decision.

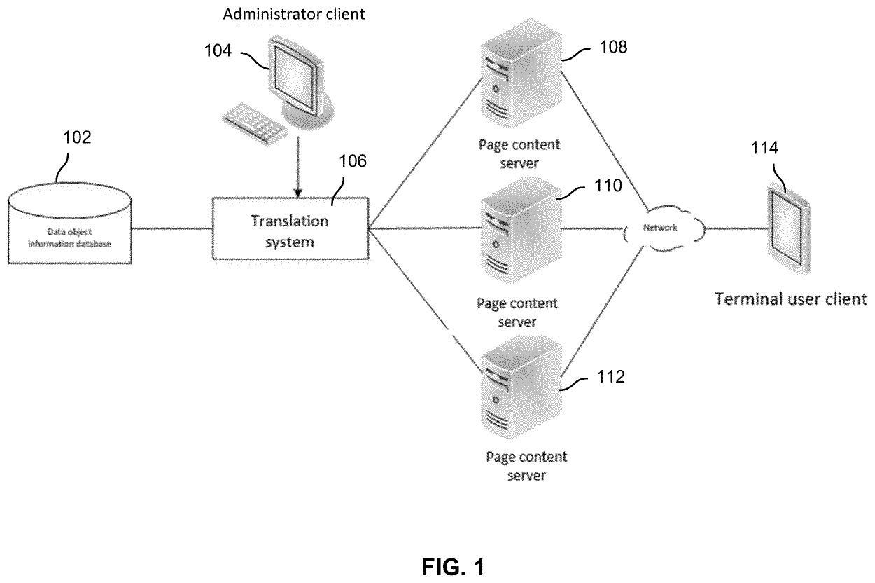

FIG. 1 is a diagram showing an embodiment of a system for translating and presenting parameter value information.

As shown in FIG. 1, data object information database 102 is configured to store information pertaining to various data objects. In some embodiments, a “data object” comprises a product. In some embodiments, “data object information” that is stored by data object information database 102 includes the data object information of each data object. For example, if a data object were a product, then corresponding data object information may include product details and specifications. In various embodiments, the information stored by data object information database 102 on each data object includes the parameter value information corresponding to each data object. In various embodiments, “parameter value information” includes numerical values corresponding to at least some parameters/attributes associated with a data object. For example, a parameter value corresponding to a data object comprises a discrete numerical value or a range of values. In some embodiments, data object information database 102 may save data object information according to categories. In some embodiments, a data object source client (not shown) is configured to provide the category and data object information (including parameter value information) of various data objects to be stored at data object information database 102. For example, the data object source client received data object category and other information from the vendors of the data objects.

In various embodiments, translation system 106 is configured to retrieve the specific parameter values of multiple data objects in each category from data object information database 102 and translate the parameter values of each data object, in accordance with specific translation rule information, into textual descriptive information. In some embodiments, translation system 106 may be implemented using a server. In some embodiments, translation system 106 is configured to store and apply specific translation rules that correspond to specific parameters and/or specific categories of data objects. Put another way, different parameters may correspond to different translation rules. For example, in the case of the phone battery capacity parameter, the corresponding translation rule may be: each different battery capacity range corresponds to different textual descriptive information. In another example, for the pixel parameter, each different pixel value range may correspond to a different textual descriptive information. Specific translation rules may segmentally describe each possible type (e.g., numerical value range) of parameter value of a single parameter and separately define specific corresponding textual descriptive information. Translation rules corresponding to specific parameters may be predefined in translation system 106. In some embodiments, an administrator of translation system 106 defines data object categories and inputs translation rules (e.g., corresponding to specific parameters and/or to different data object categories) into translation system 106. In some embodiments, “translation rules” or “translation rule information” with respect to a particular parameter comprises mappings between each range of parameters values of that particular parameter to a corresponding text-based description. Then, translation system 106 is configured to perform translation on the parameter value information corresponding to at least some parameters associated with data objects for which information is stored at data object information database 102 using the translation rules corresponding to those parameters.

In some embodiments, translation system 106 is configured to perform translation from parameter value information to textual descriptive information on a subset of parameters pertaining to each data object category. The subset of parameters of each data object category for which translation system 106 is configured to perform translation is referred to as a set of “target” parameters. A first reason to perform translation on only a subset of parameters per each data object of a particular category is that there may be a great number of possible data object parameters and parameter values may not be available (e.g., may not have been provided by a data object source client) for each data object across all the parameters. Put another way, data object information database 102 may store, for different data objects within the same category, parameter values for overlapping but not necessarily identical sets of parameters. A second reason to perform translation on only a subset of parameters per each data object of a particular category is that there may be a limited amount of area in a user interface in which to present the translated textual descriptive information corresponding to parameter values of a data object. For example, textual descriptive information corresponding to one or more data objects may be presented in a search results page that presents information on data objects that match a search query. Given that the search results page usually lists multiple data objects, for the purposes of making the presented data object information more readable and easily identifiable, the amount of textual descriptive information translated from parameter value information may be limited. Thus, in some embodiments, since the parameters of all the data objects in one category generally are the same or similar, it is possible to determine the subset of “core” (target) parameters that correspond to the same category and that specifically need to be presented and to configure translation system 106 to translate only the parameter values of these core (target) parameters for all data objects in this one category for the purpose of presenting the translations on the data object information pages of the data objects. In some embodiments, the subset of core/target parameters of a data object category for which translation is to be performed is defined by an administrator of translation system 106. An administrator of translation system 106 may have a better understanding of the data object information of an industry or category and know which parameters are the core/target parameters of concern to users or are the core/target parameters that would help users with their purchase decisions. In some embodiments, the subset of core/target parameters of a data object category for which translation is to be performed is determined by automatically analyzing all the parameters in each data object category. By selecting specific core/target parameters for each data object category, it is possible to present information corresponding to the same one or more core/target parameters when presenting translated parameter value information for different data objects in the same category. As will be illustrated in examples shown further below, by presenting the translated parameter value information of multiple data objects in a side-by-side manner at a user interface (e.g., a search results page), the standardized textual descriptive information of the data object may provide an efficient comparison of the parameters of the data objects.

In some embodiments, an administrator may use administrator client 104 to access the configuration interface provided by translation system 106 to implement settings for the information related to parameter value translation: the data object category information (e.g., definitions of categories), core/target parameter information (e.g., which data object parameters in a category are a core/target parameter), and translation rule information corresponding to each core/target parameter. Based on these configured settings, translation system 106 is configured to extract the parameter values of the core/target parameters of each data object in a category from data object information database 102 and translate those specific parameter values, based on the translation rule information, into corresponding textual descriptive information. Put another way, the inputs into translation system 106 include data object information from data object information database 102, data object category information, core/target parameter information, and/or translation rule information corresponding to each core/target parameter, and the output from translation system 106 is textual descriptive information corresponding to each data object with respect to each core/target parameter that had been configured for the category to which the data object belongs. Such textual descriptive information is used to express the specific numerical-based parameter values of the core parameters in text-based non-technical language.

In some embodiments, a connection is established between translation system 106 and each page content server (e.g., FIG. 1 shows three example page content servers including 108, 110, and 112) for a frontend page (e.g., a page that presents a data object detailed information page or a list of data objects, etc.) (e.g., over a network). For example, the frontend page is to be presented at terminal user client 114 in response to a user search query for data objects or a user request to view a data object detailed information page. After the parameter value information corresponding to data objects for which information is to be presented at a front-end page is translated by translation system 106, in some embodiments, the textual descriptive information corresponding to specific data objects may be provided by translation system 106 to the requesting specific page content server. For example, the translated textual descriptive information may be actively pushed by translation system 106 to the requesting page content server, or the translated textual descriptive information may be pulled from the translation system 106 by the requesting page content server. In this way, the requesting page content server may add textual descriptive information of this sort to a frontend page containing corresponding data object information.

In some embodiments, a page content server such as any of page content servers 108, 110, and 112 may set a page layout of a requested frontend page in advance to set aside specific expansion areas on the page for presenting translated textual descriptive information relating to the parameter values. The parameter information types, layouts, and other things that specifically need to be presented for different data object categories may be preset. Thus, after specific parameter-related translated textual descriptive information is acquired from translation system 106 from a requesting page content server, this parameter-related information may be presented in the expansion areas of the frontend page. For example, expansion areas can be provided at specific resource positions on a frontend page that presents a list of data objects (e.g., comprising search results in response to a search query), and multiple sub-areas for individually presenting information on each core/target parameter can be provided within each of these expansion areas based on the number of specific core/target parameters.

In some embodiments, translated textual descriptive information corresponding to each core/target parameter of a data object is presented without the original untranslated, numerical parameter value information within an expansion area corresponding to the data object. In some embodiments, translated textual descriptive information corresponding to each core/target parameter of a data object is presented in addition to the original untranslated, numerical parameter value information within an expansion area corresponding to the data object. In some embodiments, corresponding icon information may be provided for specific core/target parameters. For example, icon information may be related to common icons for hardware modules corresponding to parameters. For example, for a parameter relating to a webcam, a corresponding icon may resemble a traditional camera; for a battery capacity parameter, a corresponding icon may resemble a battery, and so on. Thus, in some embodiments, the presentation of each core/target parameter within an expansion area corresponding to a data object in a frontend page may include one or more of the following: an icon corresponding to the core/target parameter, a parameter value corresponding to the core/target parameter, and translated textual descriptive information generated based on the parameter value. By presenting translated textual descriptive information simultaneously with the original untranslated, numerical parameter value information at a frontend page, users can view the more technical parameter values but also receive intuitive and standardized, non-technical text-based information of the meaning of each parameter. Such a presentation may more effectively enable users to compare multiple data objects against each other.

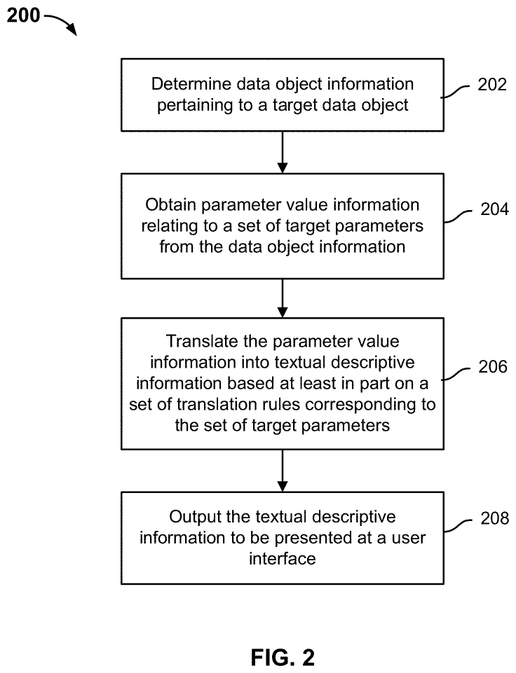

FIG. 2 is a flow diagram showing an embodiment of a process for translating parameter value information. In some embodiments, process 200 is implemented by a translation system such as translation system 106 of FIG. 1.

At 202, data object information pertaining to a target data object is determined.

In some embodiments, the translation system may provide a configuration interface, which may include operating options for entering data object information. In some embodiments, a relevant party (e.g., a vendor) may enter the ID or category of the “target data object” whose parameter value information needs to be translated and/or other such information in the translation system. In some embodiments, the data object information related to one or more data objects is stored at a data object information database. In some embodiments, the translation system is configured to actively scrape data object information from a website, a database, or documents and, in some embodiments, is also configured to determine data objects whose parameter value information is in need of translation as the target data objects. For example, the data object categories, industries, and other such information which may identify data objects whose parameter value information requires translation could be configured in advance in the translation system. In this way, the translation system could actively scrape data objects in specific categories and industries from specific data object information databases and other such systems.

At 204, parameter value information relating to a set of target parameters is obtained from the data object information.

The parameter value information of a target data object that corresponds to a set of target parameters may be extracted from the data object information that was determined for the target data objects. As mentioned above, parameter value information corresponding to fewer than all of the parameters corresponding to a data object may be obtained and those parameters for which their parameter values are to be obtained for translation are sometimes referred to as the set of “target parameters.” There are multiple possible techniques for determining which parameters of a data object are identified as the set of target parameters. In a first example, a data object vendor that provides the data object information may designate certain parameters corresponding to a data object or a category of data objects as being the set of target parameters. Put another way, when a data object vendor specifically configures the ID or category information for data objects in need of translation, the vendor may also specify core/target parameters of those data objects for which the corresponding parameter values are to be translated by the translation system. In a second example, core/target parameter information corresponding to various categories may be pre-configured in a translation system (e.g., by an administrator of the translation system). After data object ID or category information is submitted by data object vendors, the core/target parameters in need of translation may be determined directly on the basis of the stored pre-configured information. When a translation system stores pre-configured core/target parameters corresponding to various categories of data objects, the correspondences between categories and core/target parameters may likewise be preset through a manual configuration approach, or another system may automatically determine the core/target parameters in specific categories.

In some embodiments, core/target parameters within the same data object category may be automatically determined in accordance with specific data object category information. For example, the parameters of each data object in each data object category is obtained. This parameter information may be specifically described from more than one angle. For example, from one perspective, there is the question of whether specific parameters are common to all data objects in the current category. For example, mobile phone parameters include: screen size, memory, battery capacity, camera pixels, and beauty effect increase, etc. The “beauty effect increase” parameter may not be a parameter that is common to all data objects in the mobile phone category, because it is possible that not all mobile phones have a beautifying feature. Generally, however, nearly all mobile phone data objects include screen size, battery capacity, camera pixels, memory, CPU processing speed, and other such parameters. Therefore, these parameters that are common to all data objects in the mobile phone category can be classified as universal parameters for all data objects in the mobile phone category. Put another way, the set of parameters for which parameter values are available is determined for each data object in one category, and then the intersection of the sets corresponding to all data objects in that category can be determined as “a first set of parameter information.” The first set of parameter information would represent parameters for which all data objects in that data object category store available parameter values. The number of parameters in the first set of parameter information may still be rather large. Therefore, for example, a further screening may also be implemented. For example, the amount of attention paid to parameters by users can be taken into account and used to narrow down the parameters from the first set of parameter information. For example, with regard to data objects in a particular category, a count of which parameters that at least a threshold number or majority of users pay attention to is carried out through a user survey report or in some other manner such as collecting user feedback questionnaires or recording user online interaction (e.g., browsing, clicking, or other actions). For example, an industry survey found that, with regard to mobile phone data objects, the majority of users give most of their attention to screen size, camera pixels, battery capacity, and other such parameters. Therefore, it is possible through this approach to obtain, for data objects within the same category, “a second set of parameter information” to which users give most of their attention. Next, the intersection of the first set and the second set is taken to obtain the core/target parameters corresponding to this data object category.

In some embodiments, core/target parameters may also be directly determined according to just one of the first set or second set of parameter information as described above. For example, with regard to specific data object information, the more important parameters generally will be ranked higher than other parameters. Therefore, after the first set of parameter information described above is obtained, a predetermined number of parameters may be extracted therefrom according to specific parameter ranking or other such information and determined as core/target parameters corresponding to a data object category. Or, in the case of the second set of parameter information as described above, the amount of attention paid by users to each parameter is determined, and thus each parameter may be ranked according to the different amounts of attention paid. Then, a predetermined number of top-ranked parameters is extracted as the core/target parameters of the data object category.

In summary, there are multiple possible ways to determine which parameters relating to the target data objects are to be classified as the target parameters that are to be obtained. The parameter values corresponding to these core/target parameters are extracted from a data object information database corresponding to each target data object.

At 206, the parameter value information is translated into textual descriptive information based at least in part on a set of translation rules corresponding to the set of target parameters.

After the parameter values relating to target parameters of target data objects are obtained, the parameter values are translated into corresponding textual descriptive information based on translation rules corresponding to the target parameters. In some embodiments, the translation rules may be preset in the system. In some embodiments, when submitting requests to translate target data object categories, a data object vendor may specify target parameters and simultaneously submit translation rules corresponding to each target parameter. For example, a data object category that is to be translated is the mobile phone category, and the specified target parameters include battery capacity, screen size, and camera pixels.

In a first example, the translation rule corresponding to the battery capacity parameter of the mobile phone category may be as shown in Table 1, below:

TABLE 1

| | Translated textual |
|---|---|
| Parameter value range | descriptive information |
| Less than or equal to 3,300 mAh | Long-lasting standby |
| Greater than 3,300 mAh | Super-long standby |

As shown in Table 1, above, the translation rule corresponding to the battery capacity parameter specifies two ranges of parameter values (“Less than or equal to 3,300 mAh” and “Greater than 3,300 mAh”) and their respective translated textual descriptive information (“Long-lasting standby” and “Super-long standby”). As such, while the parameter values corresponding to the battery capacity parameter may be discrete values in a range of values, after they are translated based on the translation rule, the translated textual descriptive information will be standardized into one of two enumerated types of textual descriptive information.

In a second example, the translation rule corresponding to the screen size parameter of the mobile phone category is shown in Table 2, below:

TABLE 2

| | Translated textual |
|---|---|
| Parameter value range | descriptive information |
| Greater than 5 inches | Large screen |
| 4 to 5 inches | Medium-sized screen |
| Less than 4 inches | Small screen |

As shown in Table 2, above, the translation rule corresponding to the screen size parameter specifies three ranges of parameter values (“Greater than 5 inches,” “4 to 5 inches,” and “Less than 4 inches”) and their respective translated textual descriptive information (“Large screen,” “Medium-sized screen,” and “Small screen”). As such, while the parameter values corresponding to the screen size parameter may be a discrete value in a range of values, after they are translated based on the translation rule, the translated textual descriptive information will be standardized into one of three enumerated types of textual descriptive information.

In a third example, the translation rule corresponding to the camera pixels parameter of the mobile phone category is shown in Table 3, below:

TABLE 3

| | Translated textual |
|---|---|
| Parameter value range | descriptive information |
| Front-facing camera, less | Shoots standard-definition images |
| than 12.00 million pixels | |
| Front-facing camera, | Shoots high-definition images |
| greater than or equal | |
| to 12.00 million pixels | |
| Dual front-facing cameras | Dual front cameras |

As shown in Table 3, above, the translation rule corresponding to the camera pixels parameter specifies three ranges of parameter values (“Front-facing camera, less than 12.00 million pixels,” “Front-facing camera, greater than or equal to 12.00 million pixels,” and “Dual front-facing cameras”) and their respective translated textual descriptive information (“Shoots standard-definition images,” “Shoots high-definition images,” and “Dual front cameras”). As such, while the parameter values corresponding to the camera pixels parameter may be a discrete value in a range of values, after they are translated based on the translation rule, the translated textual descriptive information will be standardized into one of three enumerated types of textual descriptive information.

After the translation rule corresponding to each target parameter of a particular data object category is obtained, the parameter value of the target parameter may be obtained for the target data object and translated according to the corresponding translation rule. For example, suppose that a target data object is a particular mobile phone, and its target parameters include: battery capacity of 5,000 mAh, screen size of 4.5 inches, and 13.00 million pixels. In this case, using the translation rules described above in Tables 1, 2, and 3 for the battery capacity, screen size, and camera pixels parameters, they may be individually translated respectively as: super-long standby, medium-sized screen, and shoots high-definition images.

Using the translation processing as described herein, specific numerical parameter values corresponding to a data object may be translated into standardized non-technical, easy-to-understand text-based descriptions. Standardized text-based descriptions may more effectively be compared to each other and more efficiently convey the specifications of data objects for which information is presented at a frontend page.

At 208, the textual descriptive information is outputted to be presented at a user interface.

When textual descriptive information corresponding to the set of target parameters is presented on a data object information interface, it can more effectively help users make purchase decisions. In addition, since textual descriptive information is translated by an online translation system and is not assigned by data object publishers or vendors, the textual descriptive information may be regarded as more neutral and therefore, more credible.

In some embodiments, after the parameter values corresponding to target parameters of target data objects are translated by the translation system, the translation results are saved. For example, corresponding fields can be added in a data object information database, and the translation result information can be stored in the data object information database along with the original, untranslated parameter values corresponding to target parameters of data objects.

The textual descriptive information corresponding to the set of target parameters of a target data object is presented at a user interface. For example, a connection may be established between the translation system (or the data object information database) and a related content server of a frontend interface. The target interface information of the page content server corresponding to the target page may therefore be obtained from the translation system (which translates the parameter values corresponding to the target parameters in real-time) or from the data object information database (which stores previously generated translation results corresponding to the target parameters), and the textual descriptive information may be transmitted to the page content server so that the page content server can add the textual descriptive information to reserved expansion areas on the target page. In a first example, the target page can be a data object detailed information page at a shopping platform. In a second example, the target page may present information on a list of data objects at the shopping platform. Specifically, the data object list page may be a data object search results page, a specific theme list page, a specific vertical channel page, a specific shop data object list page, and an event page for a certain promotional event, etc. A data object list page of this sort generally may include multiple resource positions, in which each resource position is configured to present link information of one data object. In some embodiments, expansion areas may be preserved at resource positions. Thus, when data object information is being presented, the translation result information corresponding to the data objects may be presented at the resource positions. Thus, a user may easily consume information relating to these target parameters when browsing data object information using a list of data objects. Moreover, this information is conveyed to the user in non-technical, easy-to-understand language, therefore making it easier for the user to compare different data objects and potentially, make a purchase at the shopping platform. In addition, a data object list page generally presents information on multiple data objects in the same category. As described above, in some embodiments, for each data object category, a set of target parameters is selected for which corresponding parameter values are to be translated by the translation system. Therefore, the user may more effectively compare multiple data objects in the same category. For example, in the case of mobile phone-type data objects, parameter values of the three parameters of screen size, battery capacity, and camera pixels are selected as target parameters whose parameter values are to be translated. These target parameters generally are core (e.g., important) parameters of the mobile phone category and generally receive the most attention from users in the purchasing process. Therefore, the parameter values of these target parameters are translated to enable the user to more easily understand the specific conditions of the data objects and facilitate the user to more effectively make purchases at the shopping platform.

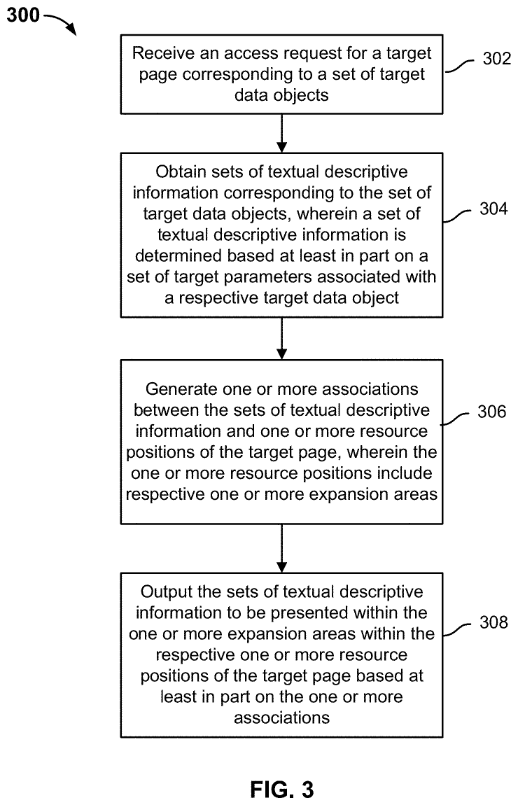

FIG. 3 is a flow diagram showing an embodiment of a process for presenting translated parameter value information. In some embodiments, process 300 is implemented by a page content server such as page content server 108, 110, and 112 of FIG. 1.

At 302, an access request for a target page corresponding to a set of target data objects is received.

In a first example, information on multiple target data objects that meet a search condition may be obtained in response to a search query for matching data objects. In a second example, information on multiple target data objects that are included in a data object category may be obtained in response to a user request to browse data object information corresponding to that category. In a third example, information on multiple target data objects that are related to a particular theme may be obtained in response to a user request to browse data object information corresponding to that theme. In a fourth example, information on multiple target data objects that are related to a particular target event venue page may be obtained in response to a user request to browse data object information related to the target event venue.

At 304, sets of textual descriptive information corresponding to the set of target data objects is obtained, wherein a set of textual descriptive information is determined based at least in part on a set of target parameters associated with a respective target data object.

A corresponding set of textual descriptive information is obtained corresponding to a set of target parameters for each target data object of the set of target data objects. The corresponding set of textual descriptive information corresponding to the target parameters of each target data object is determined by translating the target data object's parameter values corresponding to the set of target parameters into textual descriptive information. In some embodiments, the corresponding set of textual descriptive information corresponding to the target parameters of each target data object is determined by a translation system (e.g., translation system 106 of FIG. 1) using a process such as process 200 of FIG. 2, above.

At 306, one or more associations between the sets of textual descriptive information and one or more resource positions of the target page are generated, wherein the one or more resource positions include respective one or more expansion areas.

In some embodiments, a “resource position” is a particular location or area within a target page in which to present information on a particular data object. In some embodiments, the layout of resource positions at the target page may be pre-established. After the textual descriptive information corresponding to the set of target data objects is determined, associations between the target data objects and specific resource positions on the target page may be determined. For example, the target data objects may be ranked according to user personalized preferences and other such information, such that a data object list page viewed by different users for the same theme or category may not include the same target data objects or the same ranking of target data objects. The target data objects can be associated with the various resource positions in the target page based on a user's specific ranking. In another example, a uniform (e.g., user agnostic) ranking may be applied to all data objects within a same category or theme, and then the target data objects can be associated with the various resource positions in the target page based on this uniform ranking. For example, the highest ranked target data object is to be associated with the resource position of the target page that is associated with the most conspicuous display (e.g., the top resource position within a list of resource positions in a target page).

Each resource position includes an “expansion area” that is configured to present at least the textual descriptive information corresponding to the target data object with which that resource position is associated.

At 308, the sets of textual descriptive information are outputted to be presented within the one or more expansion areas within the respective one or more resource positions of the target page based at least in part on the one or more associations.

After the associations between the sets of textual descriptive information corresponding to target data objects and resource positions have been determined, it is possible to output the sets of textual descriptive information to be presented within the expansion areas of the corresponding resource positions. In some embodiments, the page content server may send the sets of textual descriptive information as page data to the terminal user client that had sent the access request. The sets of textual descriptive information from the page data may then be presented at the target page that is rendered at the terminal user client.

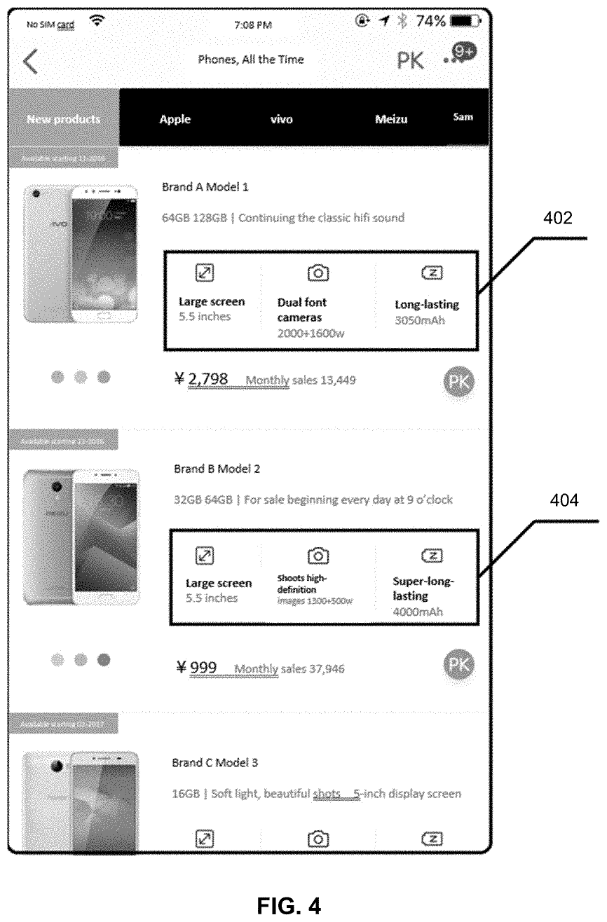

FIG. 4 is a diagram showing an example user interface of a target page. FIG. 4 shows a data object list page. As shown in FIG. 4, expansion area 402 is presenting in a resource position that is associated with the target data object “Brand A Model 1” mobile phone. Expansion area 402 presents the textual descriptive information as “large screen,” “dual front cameras,” and “long-lasting,” which are translations of the parameter values corresponding to the screen size, camera pixels, and battery capacity target parameters associated with target data object “Brand A Model 1” mobile phone. In the example of expansion area 402, the original, untranslated parameter values corresponding to the screen size, camera pixels, and battery capacity target parameters are also presented with their respective translated counterparts. Similarly, expansion area 404 presents the textual descriptive information as “large screen,” “shoots high-definition,” and “super-long-lasting,” which are translations of the parameter values corresponding to the screen size, camera pixels, and battery capacity target parameters associated with target data object “Brand B Model 2” mobile phone. In the example of expansion area 404, the original, untranslated parameter values corresponding to the screen size, camera pixels, and battery capacity target parameters are also presented with their respective translated counterparts. As shown in FIG. 4, in some embodiments, original, untranslated parameter values of the target parameters of target data objects can be presented in addition to the translated textual descriptive information and, as a result, may help the user to better understand what specific parameter values correspond to the standardized textual descriptive information.

In some embodiments, icon information of corresponding target parameters is also presented within the expansion areas with the translated textual descriptive information. For example, in the case of the screen size parameter, an icon representing screen expansion may be presented, while in the case of the battery capacity parameter, an icon representing a battery may be presented, and so on, as shown in expansion area 402 and expansion area 404. As a result of the presentation of information in the three dimensions described above, the user can more intuitively comprehend the specific parameter information of the corresponding data objects. The icon information corresponding to target parameters may be preconfigured. For example, icon configuration information may be saved on a server, and the specific parameter values and textual descriptive information may be issued to clients subsequently. In another example, icon configuration information may be preconfigured on the clients that are configured to present the target pages.

Various data objects on the same data object list page generally include multiple data objects in one category. FIG. 4 shows a data object list page that includes multiple data objects that belong to the mobile phone category or theme. Also as shown in FIG. 4, for better comparisons between different data objects of the same category or theme, the target parameters whose parameter values are translated can be the same for different data objects within the same category. For example, as shown in FIG. 4, for each specific model of mobile phone in the mobile phone category, translated textual descriptive information corresponding to the same three target parameters (screen size, battery capacity, and camera pixels) is presented.

In some embodiments, a data object list page may include a selectable operation for adding a data object to a comparison. In the example of FIG. 4, the “PK” button presented for each data object can be selected to add the corresponding data object to a separate comparative information interface that is to be generated based on the selected data objects. Thus, in the process of browsing a data object list page, a user may select one or more interesting data objects and add them to a comparative information interface. Later, the comparative information interface can be generated according to the textual descriptive information of the target parameters corresponding to the data objects that had been added to the comparison.

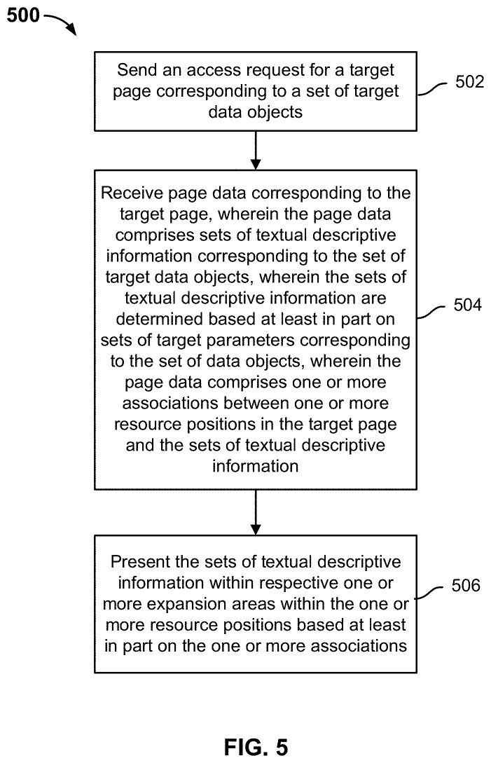

FIG. 5 is a flow diagram showing an embodiment of a process for presenting parameter value information. In some embodiments, process 500 is implemented by a terminal user client such as terminal user client 114 of FIG. 1.

At 502, an access request for a target page corresponding to a set of target data objects is sent to a server.

For example, the access request is generated by the terminal user client in response to a user input search query at a shopping platform to browse through matching data objects. In another example, the access request is generated by the terminal user client in response to a user selection at a shopping platform to browse through data objects pertaining to a selected theme.

At 504, page data corresponding to the target page is received, wherein the page data comprises sets of textual descriptive information corresponding to the set of target data objects, wherein the sets of textual descriptive information are determined based at least in part on sets of target parameters corresponding to the set of data objects, wherein the page data comprises one or more associations between one or more resource positions in the target page and the sets of textual descriptive information.

In some embodiments, the page data corresponding to the target page is determined by a page content server, to which the terminal user client had sent the access request, using a process such as process 400 of FIG. 4, above. For example, the returned page data includes the sets of textual descriptive information corresponding to the set of target data objects. The sets of textual descriptive information had been translated from parameter values of the target objects corresponding to a set of target parameters. For example, if the set of target data objects belonged to the same data object category or theme, then parameter values corresponding to the same set of target parameters that had been configured for the data object category or theme can be translated. The page data also indicates which target data object is associated with which resource position within the target page.

At 506, the sets of textual descriptive information are presented within respective one or more expansion areas within the one or more resource positions based at least in part on the one or more associations.

The corresponding set of textual descriptive information corresponding to the set of target parameters for a target data object is presented within the expansion area of the resource position that is associated with that target data object. As described above, the set of textual descriptive information corresponding to a target data object may also be presented with the original, untranslated parameter values and, optionally, icon information corresponding to each target parameter for which textual descriptive information is provided.

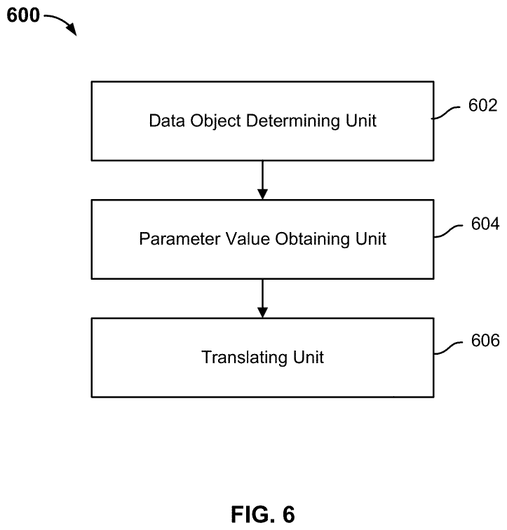

FIG. 6 is a diagram showing an example of a system for translating and presenting parameter value information. In the example of FIG. 6, system 600 includes data object determining unit 602, parameter value obtaining unit 604, and translating unit 606. In some embodiments, system 600 corresponds to a translation system.

The modules, sub-modules, and units described herein can be implemented as software components executing on one or more processors, as hardware such as programmable logic devices, and/or Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present disclosure. The modules, sub-modules, and units may be implemented on a single device or distributed across multiple devices.

Data object determining unit 602 is configured to determine data object information pertaining to a target data object.

Parameter value obtaining unit 604 is configured to obtain parameter value information from the data object information relating to a set of target parameters.

Translating unit 606 is configured to translate the parameter value information into textual descriptive information based at least in part on a set of translation rules corresponding to the set of target parameters. In some embodiments, translating unit 606 is configured to output the textual descriptive information to be presented at a user interface.

In some embodiments, system 600 further comprises:

A configuration information receiving unit that is configured to receive one or more core/target parameters allocated to a designated data object category and translation rule information corresponding to the core/target parameters.

In some embodiments, data object determining unit 602 is further configured to determine data objects in the designated data object category as the target data objects.

In some embodiments, parameter value obtaining unit 604 is further configured to: determine core/target parameter information corresponding to the designated data object category as target parameters of target data objects and extract parameter value information relating to the target parameters of the target data objects from a data object information database.

After the parameter values are translated into textual descriptive information, system 600 further includes:

An interface information determining unit that is configured to determine target interface information of a page content server corresponding to the target page.

An information transmitting unit that is configured to transmit the textual descriptive information to the page content server using the target interface information so that the page content server can add the textual descriptive information to reserved expansion areas on the target page.

In a first example, the target page comprises a data object detailed information page.

In a second example, the target page comprises a data object list page. The data object list page includes multiple resource positions. The reserved expansion areas are located in the resource positions.

The data object list pages include data object search result pages. The page content servers include servers that provide search functions.

In some embodiments, after the parameter values are translated into textual descriptive information, system 600 further includes:

A data saving unit is configured to store the textual descriptive information in a data object information database so that the page content server can acquire textual descriptive information on the corresponding data objects directly from the data object information database to present the textual descriptive information on a target page.

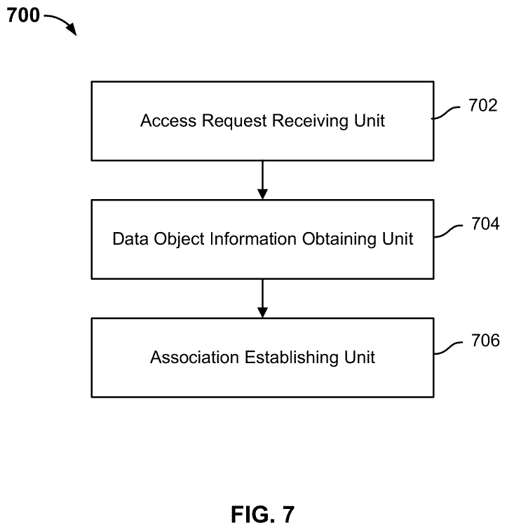

FIG. 7 is a diagram showing an example of a system for presenting translated parameter value information. In the example of FIG. 7, system 700 includes access request receiving unit 702, data object information obtaining unit 704, and association establishing unit 706. In some embodiments, system 700 corresponds to a page content server.

Access request receiving unit 702 is configured to receive an access request for a target page corresponding to a set of target data objects.

Data object information obtaining unit 704 is configured to obtain sets of textual descriptive information corresponding to the set of target data objects. As mentioned above, a set of textual descriptive information is determined based at least in part on a set of target parameters associated with a respective target data object.

Association establishing unit 706 is configured to establish associations between information on the data objects and resource positions on the target page. The resource positions comprise expansion areas and are for presenting the textual descriptive information corresponding to the associated data objects.

In some embodiments, access request receiving unit 702 is configured to receive a data object search request. As such, data object information obtaining unit 704 is configured to obtain information on multiple target data objects that meet a search condition.

In some embodiments, access request receiving unit 702 is configured to receive a request to browse data object information corresponding to a target category. As such, the data object information obtaining unit 704 may be configured to obtain information on multiple target data objects in the target category.

In some embodiments, access request receiving unit 702 is configured to receive a request to access a target theme page. As such, the data object information obtaining unit 704 may be configured to obtain information on multiple target data objects related to the target theme.

In some embodiments, access request receiving unit 702 is configured to receive a request to access a target event venue page. As such, data object information obtaining unit 704 may be configured to obtain information on multiple target data objects related to the target event venue.

In some embodiments, system 700 further comprises:

A parameter information determining unit that is configured to determine target parameter value information corresponding to the textual descriptive information.

An icon information presenting unit that is configured to determine icon information that is pre-allocated to the target parameters and that is to be presented in the expansion areas.

A parameter value determining unit that is configured to determine parameter value information that corresponds to the target parameters and that is to be presented in the expansion areas.

In some embodiments, multiple target data objects refer to multiple data objects within the same category and where the target parameters corresponding to the same category are the same.

In some embodiments, system 700 may further comprise:

A comparison operation option providing unit that is configured to provide operation options for adding corresponding data objects to a comparison.

A comparison interface providing unit that is configured to receive a comparison operation request through the operation option and, in response, generate a comparative information interface according to the textual descriptive information relating to the target parameters corresponding to the data objects that had been added to the comparison.

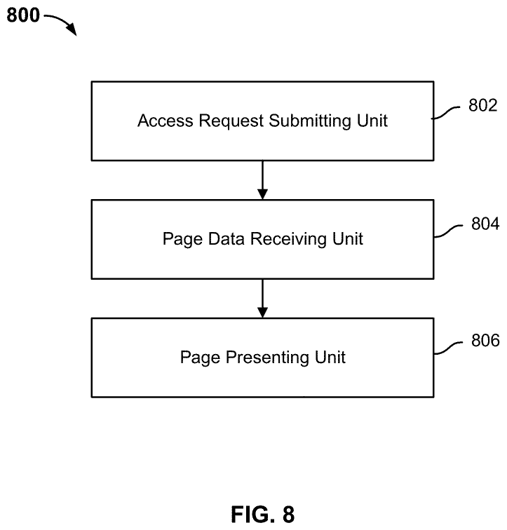

FIG. 8 is a diagram showing an example of a system for presenting translated parameter value information. In the example of FIG. 8, system 800 includes access request submitting unit 802, page data receiving unit 804, and page presenting unit 806. In some embodiments, system 800 corresponds to a terminal user client.

Access request submitting unit 802 is configured to submit an access request for a target page to a page content server.

Page data receiving unit 804 is configured to receive page data sent back by the server. The page data includes information on multiple target data objects and the relationships between each data object and a resource position on the target page. The data object information comprises sets of textual descriptive information corresponding to the target data objects. The sets of textual descriptive information are determined based on parameter values relating to target parameters of the target data objects and express the parameter values relating to the target parameters in textual rather than numerical representation. The resource positions comprise reserved expansion areas, and the expansion areas are configured to present the textual descriptive information.

Page presenting unit 806 is configured to present the target page according to the page data. The sets of textual descriptive information are presented within the respective expansion areas of the resource positions associated with corresponding target data objects.

In some embodiments, a system for translating and presenting parameter value information is a computer system that comprises one or more processors; and memory associated with the one or more processors; the memory is for storing program instructions, and the program instructions execute the following operations upon being read and executed by the one or more processors: determining data object information pertaining to a target data object; obtaining parameter value information from the parameter value information relating to a set of target parameters; and translating the parameter values into textual descriptive information based on the parameter values and translation rule information corresponding to the set of target parameters.

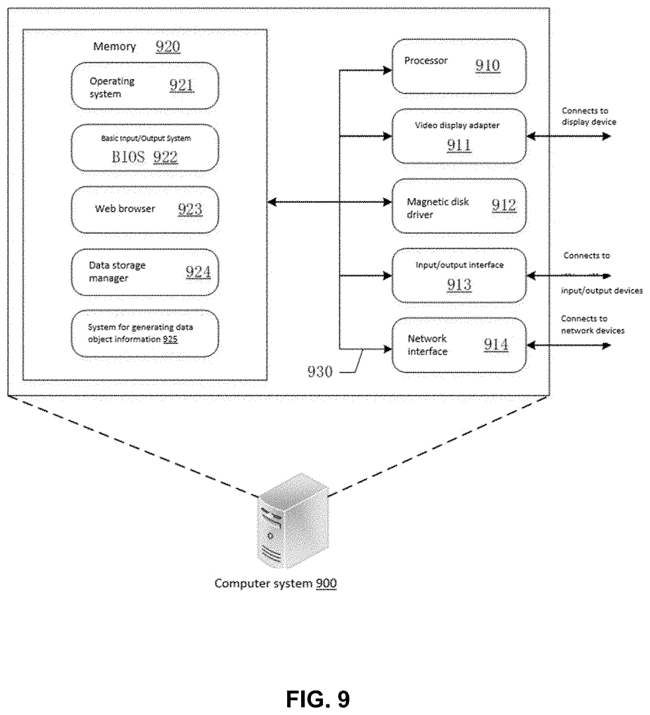

FIG. 9 is a schematic diagram that presents the architecture of a computer system. As shown in the example of FIG. 9, computer system 900 may include processor 910, video display adapter 911, magnetic disk driver 912, input/output interface 913, network interface 914, and memory 920. Processor 910, video display adapter 911, magnetic disk driver 912, input/output interface 913, network interface 914, and memory 920 may be communicatively connected through a communication bus 930.

Processor 910 may be realized in the form of a general-purpose central processing unit (CPU), microprocessor, application-specific integrated circuit (ASIC), or one or more integrated circuits, which are for executing the relevant programs in order to implement the technical scheme provided by the present application.

Memory 920 may be realized in the form of read-only memory (ROM), random-access memory (RAM), static storage devices, and dynamic storage devices. Memory 920 may store an operating system 921, which is for controlling the running of the computer system 900, and the Basic Input/Output System (BIOS), which is for controlling the low-level operations of the computer system 900. In addition, computer system 900 may also store web browser 923, data storage management system 924, system that generates data object information 925, and so on. Computer system 900 that generates data object information 925 may be an application that specifically implements each of the steps described above in an embodiment of the present application. In summary, when the technical scheme provided by the present application is implemented through software or firmware, the related program code is stored in memory 920 and is executed by processor 910.

Input/output interface 913 is for connecting to input/output modules in order to implement information input and output. The input/output modules may be components configured within the device (not shown in the drawing), or they may be externally connected to the device to provide the corresponding functions. Input devices may include keyboards, mice, touchscreens, microphones, and various kinds of sensors. Output devices may include displays, speakers, vibrators, and indicator lights.

Network interface 914 is for connecting to communication modules (not shown in the drawing) in order to implement communication between the device and other devices. The communication modules may communicate through cables (e.g., USBs or networking cables) or wirelessly (e.g., via a mobile network, WiFi, or Bluetooth).

Bus 930 includes a channel for transmitting information between various components of the device (e.g., processor 910, video display adapter 911, magnetic disk driver 912, input/output interface 913, network interface 914, and memory 920).

Please note that although the aforementioned device is depicted as having only processor 910, video display adapter 911, magnetic disk driver 912, input/output interface 913, network interface 914, memory 920, and bus 930, this device may also include other components needed to implement normal operations in the process of specific implementations. In addition, a person skilled in the art can understand that the aforementioned device may contain only the components necessary for implementing a scheme of the present application and need not contain all of the components depicted in the drawing.

In some embodiments, a system for translating and presenting parameter value information is a computer system that comprises one or more processors; and memory associated with the one or more processors; the memory is for storing program instructions, and the program instructions execute the following operations upon being read and executed by the one or more processors: submitting an access request for a target page to a server; receiving page data sent back by the server, the page data comprising information on multiple data objects and the relationships between each data object and a resource position on the target page, wherein the data object information comprises textual descriptive information corresponding to the data objects; the textual descriptive information is determined based on parameter values relating to target parameters of the data objects and is for expressing the parameter values relating to the target parameters in non-technical language; the resource positions comprise reserved expansion areas, and the expansion areas are for presenting the textual descriptive information; presenting on the target page according to the page data, wherein the textual descriptive information is presented in the expansion areas of resource positions associated with corresponding data objects.

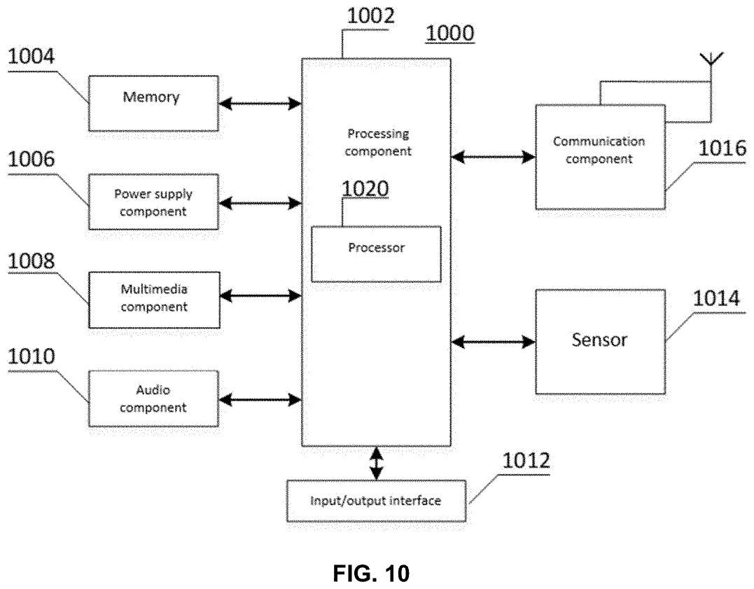

FIG. 10 is a schematic diagram showing the architecture of an electronic device. For example, device 1000 may be a mobile phone, a computer, a digital broadcast terminal, a message receiving device, a game console, a tablet, a medical device, a fitness device, a personal digital assistant, or a flight vehicle. In the example of FIG. 10, device 1000 may include the following one or more components: processing component 1002, memory 1004, power supply component 1006, multimedia component 1008, audio component 1010, input/output (I/O) interface 1012, sensor component 1014, and communication component 1016.

Processing component 1002 generally controls overall operations of device 1000, such as operations relating to display, telephone calls, data communications, camera operations, and recording operations. Processing component 1002 may include one or more processors 1020 for executing instructions to complete all or some of the steps including determining data object information pertaining to a target data object; obtaining parameter value information from the data object information relating to set target parameters; and translating the parameter value information into textual descriptive information based on the parameter value information and translation rule information corresponding to the set of target parameters. In addition, processing component 1002 may comprise one or more modules to facilitate interaction between processing component 1002 and other components. For example, the processing component 1002 may include a multimedia module to facilitate interaction between the multimedia component 1008 and the processing component 1002.

Memory 1004 is configured to store all kinds of data in support of device 1000 operations. Examples of this data include the instructions of any application program or method, contact data, telephone directory data, messages, pictures, video, and other such data used in device 1000 operations. Memory 1004 can be any combination of volatile or non-volatile memory, such as static random access memory (SRAM), electrically erasable programmable read-only memory (EEPROM), erasable programmable read-only memory (EPROM), programmable read-only memory (PROM), read-only memory (ROM), magnetic storage, flash memory, magnetic disks, or optical disks.

Power supply component 1006 provides electric power to the various components of the device 1000. Power supply 1006 can include a power supply management system, one or more power supplies, and other components related to generating, managing, and allocating power to device 1000.

Multimedia component 1008 includes an output interface screen provided between device 1000 and the user. In some embodiments, the screen may comprise a liquid crystal display (LCD) or a touch panel (TP). If the screen comprises a touch panel, the screen may be implemented as a touchscreen to receive input signals from the user. The touch panel comprises one or more touch sensors to detect touch, sliding actions, and gestures on the touch panel. The touch sensor can not only detect the boundaries of touch or slide actions, but also can measure duration and pressure related to touch or slide operations. In some embodiments, multimedia component 1008 comprises a front camera and/or rear camera. When device 1000 is in operating mode, such as a picture-taking mode or a video mode, the front camera and/or rear camera may receive external multimedia data. Each front camera and rear camera can be a fixed optical lens system or have focusing and optical zoom capabilities.

Audio component 1010 is configured to output and/or input audio signals. For example, audio component 1010 includes a microphone (MIC). When device 1000 is in an operating mode, e.g., when in calling mode, recording mode, or voice recognition mode, the microphone is configured to receive external audio signals. The received audio signals can be further stored in memory 1004 or sent by communication component 1016. In some embodiments, audio component 1010 further comprises a speaker for output of audio signals.

I/O interface 1012 provides an interface between processing component 1002 and peripheral interface modules. These peripheral interface modules may be keyboards, click wheels, buttons, etc. These buttons may include but are not limited to: homepage button, volume button, start button, and lock button.

Sensor component 1014 comprises one or more sensors and is used to provide status evaluations of various aspects of device 1000. For example, sensor component 1014 can detect the power on/off status of device 1000 and the relative positioning of components. For example, the components are a display and small keyboard of device 1000. Sensor component 1014 can further detect the following: a change in the position of device 1000 or of a component of device 1000, contact or non-contact between a user and device 1000, the orientation or acceleration/deceleration of device 1000, and a change in the temperature of device 1000. Sensor component 1014 may comprise a near sensor which is configured to detect the presence of a nearby object when there is no physical contact. Sensor component 1014 may further comprise an optical sensor, such as a CMOS or CCD image sensor for use in imaging applications. In some embodiments, sensor component 1014 may further comprise an acceleration sensor, a gyroscopic sensor, a magnetic sensor, a pressure sensor, or a temperature sensor.

Communication component 1016 is configured to facilitate wired or wireless communication between device 1000 and other devices. Device 1000 may access wireless networks based on a communications standard such as WiFi, 2G, 3G, or combinations thereof. In an exemplary embodiment, communication component 1016 receives via broadcast channels broadcast signals or broadcast-related information from external broadcast management systems. In an exemplary embodiment, communication component 1016 further comprises a near-field communication (NFC) module for promoting short-range communication. For example, it can be achieved in the NFC module on the basis of radio-frequency identification (RFID) technology, Infrared Data Association (IrDA) technology, ultra-wide band (UWB) technology, Bluetooth (BT) technology, and other technology.

In an exemplary embodiment, device 1000 can be realized by one or more application-specific integrated circuits (ASIC), digital signal processors (DSP), digital signal processing devices (DSPD), programmable logic devices (PLD), field-programmable gate arrays (FPGA), controllers, micro-controllers, microprocessors, or other electronic components for executing the method described above.

An exemplary embodiment further provides a non-transient, computer-readable medium including instructions, e.g., memory 1004 including instructions. These instructions may be executed by processor 1020 of device 1000 to complete the following: determining a target data object; obtaining parameter value information relating to a set of target parameters of the target data object; and translating the parameter values into textual descriptive information based on the parameter values and translation rule information corresponding to the set of target parameters. For example, the non-transitory computer-readable storage medium may be ROM, random-access memory (RAM), CD-ROM, magnetic tape, floppy disk, or an optical data storage device.

It must be explained that each of the embodiments contained in the present application is described in a progressive manner, the explanation of each embodiment focuses on areas of difference from the other embodiments, and the descriptions thereof may be mutually referenced for portions of each embodiment that are identical or similar. Because the means embodiments are basically similar to the method embodiments, they are described in simpler terms. Refer to the corresponding section in a method embodiment as necessary.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or devices that comprise a series of elements not only comprise those elements, but also comprise other elements that have not been explicitly listed or elements that are intrinsic to such processes, methods, things, or devices. In the absence of further limitations, for an element that is limited by the phrase “comprises a(n) . . . ”, the existence of additional identical elements in processes, methods, things, or equipment that comprise the elements is not excluded.

That which is provided by the present application has been described in detail above. This document has employed specific examples to expound the principles and embodiments of the present application. The above embodiment explanations are only meant to aid in comprehension of the methods of the present application and of its core concepts. Moreover, a person with ordinary skill in the art would, on the basis of the concepts of the present application, be able to make modifications to specific applications and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
determine data object information pertaining to a target data object;
obtain parameter value information relating to a set of target parameters from the data object information;
translate the parameter value information into textual descriptive information based at least in part on a set of translation rules corresponding to the set of target parameters; and
output the textual descriptive information to be presented at a user interface; and
one or more memories coupled to the one or more processors and configured to provide instructions to the one or more processors.

2. The system of claim 1, wherein the one or more processors are further configured to determine the set of target parameters based at least in part on stored pre-configured information.

3. The system of claim 1, wherein the target data object belongs to a target data category, wherein the set of target parameters is associated with the target data category, wherein the one or more processors are further configured to determine the set of target parameters, including to:
determine sets of parameters for which parameter values are available for data objects that belong to the target data category; and
determine an intersection of the sets of parameters as the set of target parameters associated with the target data category.

4. The system of claim 1, wherein the target data object belongs to a target data category, wherein the set of target parameters is associated with the target data category, wherein the one or more processors are further configured to determine the set of target parameters, including to:
determine a set of interested parameters related to data objects that belong to the target data category; and
determine a set of interested parameters as the set of target parameters associated with the target data category.

5. The system of claim 1, wherein the target data object belongs to a target data category, wherein the set of target parameters is associated with the target data category, wherein the one or more processors are further configured to determine the set of target parameters, including to:
determine sets of parameters for which parameter values are available for data objects that belong to the target data category;
determine an intersection of the sets of parameters as a first set of parameter information associated with the target data category;
determine a set of interested parameters related to the data objects that belong to the target data category;
determine the set of interested parameters as a second set of parameter information associated with the target data category; and
determine an intersection between the first set of parameter information associated with the target data category and the second set of parameter information associated with the target data category as the set of target parameters.

6. The system of claim 1, wherein the set of translation rules comprises for each target parameter, one or more mappings between one or more ranges of parameter values and respective one or more textual descriptive descriptions.

7. The system of claim 1, wherein the one or more processors are further configured to send the textual descriptive information to be stored corresponding to the set of target parameters associated with the target data object at a data object information database.

8. A method, comprising:
determining data object information pertaining to a target data object;
obtaining parameter value information relating to a set of target parameters from the data object information;
translating the parameter value information into textual descriptive information based at least in part on a set of translation rules corresponding to the set of target parameters; and
outputting the textual descriptive information to be presented at a user interface.

9. The method of claim 8, further comprising determining the set of target parameters based at least in part on stored pre-configured information.

10. The method of claim 8, wherein the target data object belongs to a target data category, wherein the set of target parameters is associated with the target data category, wherein the method further comprises determining the set of target parameters including by:
determining sets of parameters for which parameter values are available for data objects that belong to the target data category; and
determining an intersection of the sets of parameters as the set of target parameters associated with the target data category.

11. The method of claim 8, wherein the target data object belongs to a target data category, wherein the set of target parameters is associated with the target data category, wherein the method further comprises determining the set of target parameters including by:
determining a set of interested parameters related to data objects that belong to the target data category; and
determining a set of interested parameters as the set of target parameters associated with the target data category.

12. The method of claim 8, wherein the target data object belongs to a target data category, is wherein the set of target parameters is associated with the target data category, wherein the method further comprises determining the set of target parameters including by:
determining sets of parameters for which parameter values are available for data objects that belong to the target data category;
determining an intersection of the sets of parameters as a first set of parameter information associated with the target data category;
determining a set of interested parameters related to the data objects that belong to the target data category;
determining the set of interested parameters as a second set of parameter information associated with the target data category; and
determining an intersection between the first set of parameter information associated with the target data category and the second set of parameter information associated with the target data category as the set of target parameters.

13. The method of claim 8, wherein the set of translation rules comprises for each target parameter, one or more mappings between one or more ranges of parameter values and respective one or more textual descriptive descriptions.

14. The method of claim 8, further comprising sending the textual descriptive information to be stored corresponding to the set of target parameters associated with the target data object at a data object information database.

15. A system, comprising:
one or more processors configured to:
receive an access request for a target page corresponding to a set of target data objects;
obtain sets of textual descriptive information corresponding to the set of target data objects, wherein a set of textual descriptive information is determined based at least in part on a set of target parameters associated with a respective target data object;
generate one or more associations between the sets of textual descriptive information and one or more resource positions of the target page, wherein the one or more resource positions include respective one or more expansion areas; and
output the sets of textual descriptive information to be presented within the one or more expansion areas within the respective one or more resource positions of the target page based at least in part on the one or more associations; and
one or more memories coupled to the one or more processors and configured to provide instructions to the one or more processors.

16. The system of claim 15, wherein the target page corresponds to a detailed data object information page corresponding to a requested data object.

17. The system of claim 15, wherein the target page corresponds to a list of data objects page.

18. The system of claim 15, wherein the set of textual descriptive information is presented with a set of parameter values associated with the respective target data object corresponding to the set of target parameters.

19. The system of claim 15, wherein the set of textual descriptive information is presented with icon information associated with the set of target parameters.

20. The system of claim 15, wherein the one or more processors are configured to generate the one or more associations between the sets of textual descriptive information and the one or more resource positions of the target page based at least in part on ranking the set of target data objects.
